(19) United States
(12) Patent Application Publication
(10) Pub. No.: US 2026/0145118 A1
(43) Pub. Date: May 28, 2026

(54) PROCESS FOR TREATING FLUORINATED GASES

(71) Applicant: NuMat Technologies, Inc., Chicago, IL (US)

(72) Inventors: Mitchell Hugh Weston, Chicago, IL (US); Paul Mittonette, Haywards Heath (GB)

(73) Assignee: NuMat Technologies, Inc., Chicago, IL (US)

(21) Appl. No.: 19/399,021

(22) Filed: Nov. 24, 2025

Related U.S. Application Data
(60) Provisional application No. 63/724,835, filed on Nov. 25, 2024.

(51) Int. Cl. B01D 53/047; B01D 53/04; B01D 53/38; B01D 53/68; B01D 53/75; B01D 53/82; B01D 53/96

(52) U.S. Cl. CPC B01D 53/0476; B01D 53/0462; B01D 53/38; B01D 53/685; B01D 53/75; B01D 53/82; B01D 53/96; B01D 2253/10; B01D 2256/26; B01D 2257/80

(57) ABSTRACT

A process for treating gases comprising fluorinated compounds is disclosed. The process comprises passing a dilute fluorinated compound gas stream comprising a fluorinated compound to a scrubber to scrub it of reactive gases. A scrubbed gas stream is discharged from the scrubber and fed to an adsorption unit to adsorb one or more fluorinated compounds onto an adsorbent. One or more fluorinated compounds are desorbed from the adsorbent. A concentrated gas stream comprising a higher concentration of the fluorinated compounds than the feed gas stream is discharged from the adsorption unit.

### FIELD

This disclosure relates to a process for treating gases. Particularly, the disclosure relates to a process of treating exhaust gases discharged from a semiconductor etching tool.

### BACKGROUND

The semiconductor industry uses perfluorinated compounds including carbon tetrafluoride, hexafluoroethane, octafluoropropane, perfluorobutane, fluoroform, sulfur hexafluoride, nitrogen trifluoride, and the like, in semiconductor manufacturing processes, particularly in various etching steps of the semiconductor manufacturing processes as well as in the chamber cleaning step of the manufacturing process. Such perfluorinated compound gases are used either pure or diluted, for example with nitrogen or other inert gas or in admixture with other perfluorinated compound gases or other carrier gases (for example inert gases). All of the perfluorinated compound gases do not necessarily react with other species during the manufacturing processes. Most of the perfluorinated compounds (also called “PFCs”) have lifetimes measured in thousands of years in the atmosphere and are also strong infrared absorbers. Although nearly inert with low toxicity, PFCs have high global warming potential.

The global consumption of perfluorinated compound gas used in semiconductor processes make up a significant portion of total global consumption of these gases. Other industries using perfluorinated gases include refrigeration, firefighting aerosols and aerospace. The perfluorinated compound gas may also be referred to as a semiconductor etch gas. The gases used in semiconductor etching processes may include fluorinated compound gases such as carbon tetrafluoride and nitrogen trifluoride. These gases are decomposed in the process, resulting in the creation of various fluorinated compound gases. In other semiconductor processes, gases and by products such as silane, nitrogen trifluoride, hydrogen fluoride, silicon tetrafluoride, boron trichloride, hydrogen chloride, tetrafluoromethane, sulfur hexafluoride, trifluoromethane, nitrous oxide, chlorine trifluoride, tungsten hexafluoride, nitric oxide, dichlorosilane (DCS), phosphine, arsine, boron trifluoride and the like can also be found. In addition, solid particles can be created such as silicon oxides and metal oxides.

Since some of the gases and solid particles found in typical semiconductor exhaust gases can be very harmful to the human body and other gases are suspected to have high global warming potential, the semiconductor production process generally treats the exhaust gas in a post-treatment apparatus known as abatement. Various strategies for reduction of perfluorinated compound emissions from semiconductor processing have been explored. One such strategy includes combustion-based decomposition processes for the perfluorinated compounds. In decomposition processes, the direct combustion method or the plasma decomposition method are used. During the decomposition process, a flame, plasma or other heat source is used to supply thermal energy for the split of the perfluorinated compounds into smaller molecules such as CO₂ and HF which can then be absorbed in water. All of these decomposition processes require high levels of energy in the form of electrical energy or in the form of energy from combusted gases such as natural gas, propane or hydrogen. In the case of using energy from combustion of natural gas or propane, this process itself generates environmental emissions during the process of reducing environmental emissions from the semiconductor process itself.

It is an object of the disclosure to capture or recover the PFC's discharged from semiconductor etchant tools such that the PFC's can be re-used without the need for expensive abatement systems which can themselves create emissions either directly or indirectly.

It is another object of the disclosure to provide a process for treating gases comprising fluorinated compounds.

It is another object of the disclosure to provide a process for treating an exhaust stream of etchant tools that contain one or more highly reactive corrosive compounds.

### SUMMARY OF THE DISCLOSURE

The foregoing objects of the disclosure are met by a process for treating gases, wherein the gases are discharged from a semiconductor etching tool or tools. The gas stream discharged from the semiconductor etching tool may comprise about 0.1 mole % to about 10 mole % fluorinated compounds including perfluorinated compounds. The fluorinated compounds may comprise one or more from hexafluoroethane (C₂F₆), difluoromethane (CH₂F₂), trifluoromethane (CF₃H), octafluoropropane (C₃F₈), octafluorocyclobutane (C₄F₈), tetrafluoromethane (CF₄), sulphur hexafluoride (SF₆), and nitrogen trifluoride (NF₃). The fluorinated compounds may include other fluorinated or perfluorinated compounds.

An embodiment of the present disclosure is a process for treating gases. The process comprises treating a dilute fluorinated gas stream comprising a fluorinated compound. The fluorinated compound may include one or more of hexafluoroethane, difluoromethane, trifluoromethane, octafluoropropane, octafluorocyclobutane, tetrafluoromethane, sulphur hexafluoride, and nitrogen trifluoride. The dilute fluorinated gas stream may comprise at least two fluorinated compounds. Further, some reactive gases or acid gases from other semiconductor processes may be present in the dilute fluorinated gas stream. The gas stream is sent to a scrubber to remove the reactive gases. A scrubbed gas stream is then charged to an adsorption unit to adsorb fluorinated compounds onto an adsorbent. The fluorinated compounds are then desorbed from the adsorbent to provide a concentrated fluorinated compound gas stream that is discharged from the adsorption unit.

In an aspect, the dilute fluorinated gas stream is discharged from a semiconductor etching tool or tools. The adsorbent may be selected from a group comprising one or more metal-organic frameworks, activated carbon, zeolites, silica, alumina and porous polymers. The process may further comprise cooling the scrubbed gas stream in a cooler to separate water vapor in a liquid stream from a stream comprising the fluorinated compounds. Further, the liquid stream may be returned to the wet scrubber for re-use. The process may further comprise dehydrating the scrubbed gas stream to produce a dehydrated gas stream comprising less than 3 ppm by volume of water and charging the dehydrated gas stream to the adsorption unit. In an embodiment, the gas stream is taken from a gas collection header that receives a plurality of untreated etch gas streams comprising fluorinated compounds. The gas stream may be compressed to provide a compressed gas stream having a pressure of about 100 kPa (gauge) to about 600 kPa (gauge). The compressed gas stream may be scrubbed in a scrubber. The scrubbed gas stream may be compressed to provide a compressed gas stream at a pressure of about 200 kPa (gauge) to about 600 kPa (gauge) and the compressed gas stream passed to the cooler.

### SUMMARY OF THE DRAWINGS

FIG. 1 is a schematic diagram of a process for treating gases in accordance with an embodiment of the present disclosure.

FIG. 2 is a schematic diagram of an adsorption unit for treating gases in accordance with an exemplary embodiment of the present disclosure.

FIG. 3 is a schematic diagram of an adsorption unit for treating gases in accordance with another exemplary embodiment of the present disclosure.

### DEFINITIONS

As used herein, the term “fluorinated compound” means a molecule that contains fluorine atoms, including but not limited to a perfluorinated compound.

As used herein, the term “perfluorinated compound” means a hydrocarbon molecule in which some and typically all of the hydrogen atoms have been replaced by fluorine atoms.

### DETAILED DESCRIPTION

Disclosed herein is a process for treating gases discharged from a semiconductor etching tool. The gas stream may comprise one or more fluorinated compounds including perfluorinated compounds which are concentrated and recovered. The fluorinated compounds may include one or more of hexafluoroethane (C₂F₆), difluoromethane (CH₂F₂), trifluoromethane (CF₃H), octafluoropropane (C₃F₈), octafluorocyclobutane (C₄F₈), tetrafluoromethane (CF₄), sulphur hexafluoride (SF₆), and nitrogen trifluoride (NF₃).

An etching process emits fluorinated compound gas in a semiconductor production process. The etching process uses gases such as fluorinated compounds in a plasma state to create microscopic semiconductor device components. The etching process produces fluorine atoms that react on the semiconductor surface in a predetermined pattern to selectively remove the substrate. One semiconductor wafer may require many process steps using etch gases. One of the primary steps in the fabrication of modern semiconductor devices is the formation of a layer, such as a silicon oxide layer, on a substrate or wafer. Conventionally, such a layer can be deposited by chemical vapor deposition (CVD). Unwanted deposition on areas such as the walls of the processing chamber also occurs during such CVD processes. Typically, an etchant gas, such as a fluorinated compound gas, is introduced into the chamber to remove the deposited material from the chamber walls and other areas. The etchant gas reacts with and removes the deposited material from the chamber walls. So, the etching process and the chamber cleaning process can produce gases comprising one or more fluorinated compound gas.

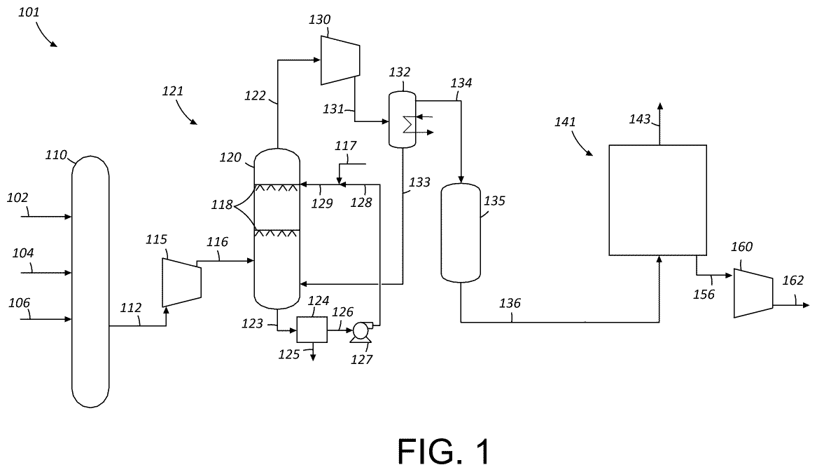

As shown in FIG. 1, a process 101 is disclosed for treating gases. In an aspect, the gases are discharged from a semiconductor etching process or etching tool. The process 101 may comprise a cleaning section 121 and an adsorption unit 141. In an embodiment, the gases discharged from the semiconductor etching tool are passed to a gas collection header 110. The gas collection header 110 may receive one or more gas streams comprising fluorinated compounds discharged from the semiconductor etching tool or tools before passing them to the cleaning section 121. In an aspect, the gas collection header 110 may receive the exhaust gases from the semiconductor etching process tool or tools.

In an exemplary embodiment, a plurality of gas streams discharged from one or more semiconductor etching tools may be taken in a first gas line 102, a second gas line 104, and a third gas line 106 and passed to the gas collection header 110. The gas streams discharged from the semiconductor etching tool comprise dilute fluorinated gases including perfluorinated compounds. The fluorinated compounds may include C₂F₆, CH₂F₂, CF₃H, C₃F₈, C₄F₈, CF₄, SF₆, and NF₃. The dilute fluorinated gas streams discharged from the semiconductor etching tool may also comprise one or more reactive acid gases which may include chlorine, fluorine, boron trichloride, nitrogen dioxide, nitrosyl chloride, carbon monoxide, carbonyl fluoride, hydrogen fluoride, hydrogen chloride, silicon tetrafluoride, sulfur dioxide, and sulfuryl fluoride.

In an aspect, the dilute gas streams discharged from the semiconductor etching tool in lines 102, 104, and 106 may comprise fluorinated compounds. In an exemplary embodiment, the dilute gas streams discharged from the semiconductor etching tool in lines 102, 104, and 106 may comprise about 0.1 mole % to about 10 mole % fluorinated compounds, or about 0.2 mole % to about 5 mole % fluorinated compounds, or about 0.5 mole % to about 2.0 mole % fluorinated compounds. In an aspect, the gas streams in lines 102, 104, and 106 may be combined to provide a combined gas stream and passed to the gas collection header 110. Typically, an inert purge gas which may comprise nitrogen is added to the exhaust flow from the semiconductor etching tool. Alternatively, argon gas may be the inert purge gas added to the exhaust flow from the semiconductor etching tool. In an embodiment, one or more of the dilute fluorinated gas streams discharged from the semiconductor etching tool in lines 102, 104, and 106 may comprise nitrogen.

A dilute fluorinated gas stream comprising a fluorinated compound is discharged in line 112 from the gas collection header 110. The dilute fluorinated gas stream in line 112 may include at least two fluorinated compounds. In some cases, the dilute fluorinated gas stream in line 112 may include at least three fluorinated compounds. The fluorinated compounds may be selected from C₂F₆, CH₂F₂, CF₃H, C₃F₈, C₄F₈, CF₄, SF₆, and NF₃. The dilute fluorinated gas steam in line 112 may comprise about 0.1 mole % to about 10 mole % fluorinated compounds, or about 0.2 mole % to about 5 mole % fluorinated compounds, or about 0.5 mole % to about 2.0 mole % fluorinated compounds.

The dilute fluorinated gas stream in line 112 may include one or more reactive gases which may comprise acid gases. The reactive gases may be selected from chlorine, fluorine, boron trichloride, nitrogen dioxide, nitrosyl chloride, carbon monoxide, carbonyl fluoride, hydrogen fluoride, hydrogen chloride, silicon tetrafluoride, sulfur dioxide, and sulfuryl fluoride, which is not an exhaustive list. The dilute fluorinated gas stream in line 112 is passed to the cleaning section 121 to remove the reactive gases prior to capture, concentration and recovery of the fluorinated compounds in the dilute fluorinated gas stream in line 112 discharged from the semiconductor etching tools. In an embodiment, the dilute fluorinated gas stream in line 112 may be compressed to a first pressure in a first compressor 115 to provide a first compressed gas stream in line 116. In an exemplary embodiment, the dilute fluorinated gas stream in line 112 may be compressed in the first compressor 115 operating at an outlet pressure of about 100 kPa (gauge) to about 600 kPa (gauge) to provide the first dilute fluorinated compressed gas stream in line 116. In an aspect, the first compressor 115 is a low-pressure compressor. The first compressed dilute fluorinated gas stream in line 116 is charged to a scrubber 120.

Dry scrubbers vary greatly with regard to energy requirements which range from a simple fixed bed adsorption system having low power consumption levels, to a heated reagent bed having a power consumption which approaches that of a catalytic system. Primary distinctions between various dry scrubbers are physical adsorption, and chemical adsorption. Physical adsorption refers to condensation or molecular trapping processes which occur within the requisite material matrix. Chemical adsorption refers to a combination of physical adsorption and surface chemical reaction processes which bind the molecules of concern to the requisite material matrix. Often chemical adsorption systems require added thermal energy to promote the necessary surface reactions. In both types of dry scrubbers, the common concerns are premature clogging of the material matrix by particulate formed upstream, and a limited capacity which requires regular replacement and disposal of the material matrix.

Wet scrubbers require relatively meager amounts of energy for operation since their functionality extends from the inherent chemical affinity between the scrubbing solution and the process gases being treated. Both chemical reactivity and solubility are principal parameters affecting the efficiency and capacity of the scrubbing process.

In an embodiment, the first compressed dilute fluorinated gas stream in line 116 is charged to a wet scrubber 120. In the wet scrubber 120, the first compressed dilute fluorinated gas stream in line 116 is contacted counter-currently with an absorption liquid stream in line 129. The wet scrubber 120 comprises at least one spray system 118 with nozzles to which the absorption liquid stream in line 129 is supplied for atomization or distribution by the nozzles. The wet scrubber 120 may comprise a sprayer or distribution system 118 for contacting the first compressed dilute fluorinated gas stream in line 116 with the absorption liquid. The absorption liquid stream in line 129 contacts and absorbs the contaminants such as reactive gases and acid gases from the first compressed dilute fluorinated gas stream in line 116 to produce a scrubbed gas stream. The scrubbed gas stream is taken in line 122 from the overhead of the wet scrubber 120 depleted of reactive gases and acid gases. A spent absorption liquid stream is taken from the bottom of the wet scrubber 120 in a bottoms line 123 rich in absorbed acid gases. The spent absorption liquid stream in line 123 may be passed to an effluent hold-up vessel 124. A sludge comprising the contaminants is separated and removed from the effluent hold-up vessel 124 in line 125. A cleaned-up absorption liquid stream is discharged in line 126 from the effluent hold-up vessel 124. The cleaned-up absorption liquid stream in line 126 is passed to a circulating pump 127. A recycle absorption liquid stream in line 128 is charged to the wet scrubber 120. In an embodiment, the recycle absorption liquid stream in line 128 may be combined with a fresh absorption liquid stream in line 117 to provide the absorption liquid stream in line 129 that is passed to the wet scrubber 120. In an exemplary embodiment, the absorption liquid stream in line 129 may comprise a caustic or alkali stream.

The scrubbed gas stream in line 122 comprises a reduced concentration of contaminants such as reactive gases and acid gases as compared to the dilute fluorinated gas stream in line 112. The scrubbed gas stream in line 122 may comprise some vapor from the absorbent liquid which must be removed before passing it to the adsorption unit 141. The scrubbed gas stream in line 122 is compressed to a second pressure in a second compressor 130 to provide a second compressed gas stream in line 131. In an exemplary embodiment, the scrubbed gas stream in line 122 is compressed to a second pressure of about 200 kPa (gauge) to about 600 kPa (gauge) in the second compressor 130 to provide the second compressed scrubbed gas stream in line 131. The second compressed scrubbed gas stream in line 131 may be cooled in a cooler 132 to condense vapor from the absorbent liquid. A liquid stream comprising water may be separated from a gas stream in line 133 from the cooler 132. A gas stream comprising absorbent vapor, inert gas and the fluorinated compounds is discharged from the cooler 132 in line 134. The liquid stream in line 133 may be recycled to the wet scrubber 120 at an inlet location below an inlet for the first compressed gas stream in line 116. The cooled second compressed scrubbed gas stream in line 134 is passed to the adsorption unit 141.

The cooled second compressed scrubbed gas stream in line 134 may be passed to a dehumidifier 135 for dehumidification in route to the adsorption unit 141. The dehumidifier 135 may comprise one or both of a desiccant and a cold trap. A cold trap is a device that condenses vapor or gas stream, except the permanent gases such as hydrogen, oxygen, and nitrogen, into liquid or solid. A dehumidified gas stream in line 136 is passed to the adsorption unit 141. In an exemplary embodiment, the dehumidified gas stream in line 136 comprises less than about 20 ppmv water, suitably less than about 3 ppmv water and preferably less than about 1 ppmv water. In an aspect, the dehumidifier 135 is optionally used and the cooled second compressed scrubbed gas stream in line 134 may be passed directly to the adsorption unit 141. A dehumidified gas stream may comprise dilute fluorinated gas stream of at least two fluorinated compounds selected from C₂F₆, CH₂F₂, CF₃H, C₃F₈, C₄F₈, CF₄, SF₆, and NF₃. The dilute fluorinated gas stream may comprise about 0.1 mole % to about 10 mole % fluorinated compounds, or about 0.2 mole % to about 5 mole % fluorinated compounds, or about 0.5 mole % to about 2.0 mole % fluorinated compounds.

In accordance with the present disclosure, the adsorption unit 141 may comprise one or more of pressure swing adsorption (PSA), thermal swing adsorption (TSA) and vacuum swing adsorption (VSA).

In an exemplary embodiment, the adsorption unit 141 comprises a PSA unit. The PSA unit 141 comprises a pressure swing adsorption step wherein fluorinated compounds are initially selectively adsorbed onto the adsorbent while the remaining gas passes through. At least one desorption step follows for desorption of the fluorinated compounds from the adsorbent material driven primarily by a swing in pressure of the PSA vessel comprising the adsorbent material. In an alternative embodiment, alternative desorptive mechanisms such as the use of vacuum, or thermal heating of the adsorbent material may also be used alone or in combination with pressure swing for desorption of the fluorinated compounds, for example. In yet another alternative, the adsorptive gas separation step may comprise a partial pressure swing adsorption (hereinafter “PPSA”) process, wherein at least one desorption step for desorption of the fluorinated compounds adsorbed on the adsorbent material is driven primarily by a swing or difference in partial pressure or concentration of at least one fluorinated compound in the PSA vessel comprising the adsorbent material. In another alternative embodiment, alternative adsorptive mechanisms such as thermal heating of the adsorbent material or pressure swing may also be used alone or in combination with partial pressure swing for desorption of adsorbed combustion gas components, for example. The PSA unit 141 may comprise two or more beds of the adsorbent material.

In another exemplary embodiment, the adsorption unit 141 comprises a TSA unit. The TSA unit 141 comprises a thermal swing adsorption step, wherein at least one desorption step for desorption of the fluorinated compounds adsorbed on an adsorbent material is driven primarily by thermal heating of the adsorbent material. In an alternative embodiment though, alternative desorptive mechanisms such as purge or displacement purge with a suitable purge fluid may also be used alone or in combination with thermal heating for the desorption of adsorbed components in the TSA unit 141. The TSA unit 141 may comprise two or more beds of the adsorbent material.

In yet another exemplary embodiment, the adsorption unit 141 comprises a VSA unit. In a VSA unit 141, as compared to a PSA unit, the adsorbed fluorinated compounds are desorbed at atmospheric or a lower pressure using a vacuum pump. The VSA unit 141 may comprise two or more beds of the adsorbent material.

In an aspect, the adsorption unit 141 is a pressure swing adsorption (PSA) unit. PSA unit 141 may include a series of multiple adsorbent beds containing one or a combination of multiple adsorbents suitable for adsorbing the fluorinated compounds to be adsorbed therein. These adsorbents may include, but are not limited to, one or more metal-organic frameworks (MOFs), activated alumina, silica gel, activated carbon, zeolitic molecular sieves, or any combination thereof. The adsorbents are organized in any sequence as required by the adsorption process to adsorb the fluorinated compounds. In the PSA unit 141, the dehumidified gas stream in line 136 flows over the adsorbents and the fluorinated including perfluorinated compounds are adsorbed during the adsorption step. The rest of the gas such as inert nitrogen gas passes through the adsorbent and discharges in a purified gas stream in line 143. Periodically, flow to the adsorbent bed is terminated, pressure reduced, so the gas stream containing a concentrated mixture of fluorinated compounds and inert gas can be removed from the adsorption unit 141. In an exemplary embodiment, the PSA unit 141 may comprise one or more adsorbents selected from a group comprising one or more of metal-organic frameworks, activated carbon, zeolites, silica, alumina and porous polymers.

In an exemplary embodiment, the PSA unit 141 may comprise two adsorption columns, a first adsorption column and a second adsorption column for adsorbing the fluorinated compounds from the dehumidified gas stream in line 136. The two adsorbent columns may be operated in a lead-lag arrangement.

In another exemplary embodiment, the first adsorption column and the second adsorption column may comprise a metal-organic framework adsorbent for adsorbing the fluorinated compounds from the dehumidified gas stream in line 136.

MOFs are well known porous adsorbents with high surface areas. MOFs comprise metal ion corner atoms and an at least bidentate linker molecule or a ligand, which is connected to the corner atom(s) thereby forming a framework structure. The metals of the clusters and the ligands each can be selected to control both the porosity of the MOF and its ability to chemically interact with other molecules. Thus, MOFs can be designed and selected to optimize both adsorbency and degradation activity toward a particular one or more fluorinated compounds. MOFs can be provided in particle sizes ranging from nano-sized particles to up to 500 microns in diameter. The as-synthesized MOF powders of any size may be formed into MOF adsorbent shaped bodies wherein substantially each adsorbent shaped body comprises a substantially random mixture of MOF particles and a binder. Smaller MOF particles can be included in a shell of a core-shell structure of the second embodiment. Larger MOF particles can be used as the core of a core-shell structure of the third embodiment; such larger particles can be single crystals or can be formed by conventional aggregation techniques to form a core of a desired size.

There are several ways to prepare MOF compositions but the most commonly used one is the solvothermal synthesis. For example, see Y. Sun and H. Zhou, Recent Progress in the Synthesis of Metal Organic Frameworks, Sci. Technol. Adv. Mater. 16 (2015). In this procedure a metal salt and the desired ligand/linker are dissolved in an appropriate solvent and reacted at an elevated temperature for a required time. Once the MOF is formed, the powder is isolated from the reaction mixture, washed and dried.

MOFs can be activated by heating, typically under reduced pressure, to remove solvent from the MOF composition. “Activated” as used herein with respect to MOFs means that the MOF adsorbs more of a fluorinated compounds than an as synthesized MOF. For example, the activated MOF can adsorb at least 10 wt % more or at least 20% more or at least 30% more or at least 40% more or at least 50% more, or at least 60% more, or at least 70% more, or at least 80% more, or at least 90% more, or at least 99.9% more than an as-synthesized MOF. The activated MOF can adsorb 2, 3, 5, 10, 15, 20, 30, 50, or 100 times the amount of fluorinated compounds versus an as-synthesized MOF.

MOFs can include one or more metal ions including but not limited to Li⁺, Na⁺, K⁺, Rb⁺, Be²⁺, Mg²⁺, Ca²⁺, Sr²⁺, Ba²⁺, Sc³⁺, Y³⁺, Ti⁴⁺, Zr⁴⁺, Hf⁴⁺, V⁵⁺, V⁴⁺, V³⁺, Nb³⁺, Ta³⁺, Cr³⁺, Cr²⁺, Mo³⁺, W³⁺, Mn³⁺, Fe³⁺, Fe²⁺, Ru³⁺, Ru²⁺, Os³⁺, Os²⁺, Co³⁺, Co²⁺, Ni²⁺, Ni⁺, Pd²⁺, Pd⁺, Pt²⁺, Pt⁺, Cu²⁺, Cu⁺, Ag⁺, Au⁺, Zn²⁺, Al³⁺, Ga³⁺, In³⁺, Si⁺, Si²⁺, Ge⁺, Ge²⁺, Sn⁴⁺, Sn²⁺, Bi⁵⁺, Bi³⁺, Cd²⁺, Mn²⁺, Tb³⁺, Gd³⁺, Ce³⁺, La³⁺, and Cr⁴⁺, and mixtures thereof. A subgroup of the metal ions is selected from Ti⁴⁺, Zr⁴⁺, Hf⁴⁺, Fe³⁺, Fe²⁺, Co³⁺, Co²⁺, Ni²⁺, Ni²⁺, Cu²⁺, Cu⁺, Zn²⁺, Ga³⁺, Al³⁺ and mixtures thereof. From this subgroup one subgroup of metal ions includes those selected from Ti⁴⁺, Zr⁴⁺, Fe³⁺, Co³⁺, Ni²⁺, Cu²⁺, Zn²⁺, Ga³⁺, Al³⁺ and mixtures thereof. Another subgroup of metal ions includes Fe³⁺, Cu²⁺, Zr⁴⁺, and Zn²⁺. In one embodiment the metal ion is Zr⁴⁺.

The metal ion corner atoms are joined by at least bidentate organic linker molecules comprising two or more sites capable of binding to a metal ion corner atom to form a metal organic framework structure. Optionally, at least bidentate inorganic linker molecules also can be used. The at least bidentate organic linker molecules include but are not limited to those having a saturated or unsaturated alkyl or aryl backbone, optionally comprising one or more heteroatoms S, N, O, or P, and optionally comprising one or more functional groups bonded to the backbone. In certain embodiments the linker backbone can comprise one or more groups selected from 1) saturated or unsaturated, linear, branched or cyclic alkyl groups having from 1 to 10 carbon atoms and optionally comprising heteroatoms; and 2) groups comprising 1 to 5 aryl or heteroaryl rings which can be fused or joined covalently; wherein the hetero atoms are selected from S, N, O, P and mixtures thereof. The backbones of the linker molecules may have bonded thereto one or more functional groups, including but not limited to saturated and unsaturated alkyl, aryl, heteroaryl, halide, —OH, —NH₂, —COOH, NO₂, COH, CO(NH₂), CN and thiols. In one embodiment the functional groups are selected from COOH and NH₂.

Silicon halides such as SiF₆ also may be used as linkers in the framework structure.

A subgroup of these ligands includes substituted or unsubstituted, mono- or polynuclear aromatic di-, tri- and tetracarboxylic acids and unsubstituted or substituted, with at least one hetero atom, aromatic di-, tri- and tetracarboxylic acids. In one embodiment the ligands include without limitation 1,3,5-benzene tricarboxylic acid (BTC), triazine tris-benzoic acid (TATB), 2-amino-terephthalic acid, naphthalene dicarboxylate (NDC), acetylene dicarboxylate (ADC), benzene-1,4-dicarboxylic acid (BDC), benzene tribenzoate (BTB), methane tetrabenzoate (MTB), adamantane tetracarboxylate (ATC), adamantane tribenzoate (ATB), 4,4′,4″,4″″-(pyrene-1,3,6,8-tetrayl)tetrabenzoic acid (TBAPy), meso-Tetraphenylporphine-4,4′,4″,4′″-tetracarboxylic acid (TCPPH2), 3,3′,5,5′-azobenzenetetracarboxylic acid, 2,5-dihydroxyterephthalic acid, pyrazine, 1,4-diazabicyclo [2.2.2]octane, pyridine-4-carboxylic acid and mixtures thereof. In one embodiment the ligands include without limitation terephthalic acid, azobenzene tetracarboxylic acid, trimesic acid, 1,4-diazabicyclo [2.2.2]octane, isonicotinic acid and mixtures thereof.

Specific MOFs suitable for use in the adsorption unit 141 may include without limitation MOF-808 which comprises Zr⁴⁺ cornerstones and trimesic acid ligands; UiO-66 which comprises Zr⁴⁺ cornerstones and terephthalic acid ligands; UiO-66—NH₂ which comprises Zr⁴⁺ cornerstones and amino-terephthalic acid ligands; PCN-250 which comprises Fe³⁺ and azobenzene tetracarboxylic acid ligands; IISERP-MOF2 which comprises Ni²⁺ and isonicotinic acid ligands, SBMOF-1 which comprises Ca²⁺ and sulfonyldibenzoic acid, and mixtures of any of the foregoing.

In some embodiments the MOFs can be impregnated such as with metal salts prior to incorporation in the adsorbent granules. In one embodiment the MOFs can be impregnated with metal salts based on any of Li⁺, Na⁺, K⁺, Rb⁺, Be²⁺, Mg²⁺, Ca²⁺, Sr²⁺, Ba²⁺, Sc³⁺, Y³⁺, Ti⁴⁺, Zr₄₊, Hf⁴⁺, V⁵⁺, V⁴⁺, V³⁺, Nb³⁺, Ta³⁺, Cr³⁺, Cr²⁺, Mo³⁺, W³⁺, Mn³⁺, Fe³⁺, Fe²⁺, Ru³⁺, Ru²⁺, Os³⁺, Os²⁺, Co³⁺, Co²⁺, Ni²⁺, Ni⁺, Pd²⁺, Pd⁺, Pt²⁺, Pt⁺, Cu²⁺, Cu⁺, Ag⁺, Au⁺, Zn²⁺, Al³⁺, Ga³⁺, In³⁺, Si⁴⁺, Si²⁺, Ge⁴⁺, Ge²⁺, Sn⁴⁺, Sn²⁺, Bi⁵⁺, Bi³⁺, Cd²⁺, Mn²⁺, Tb³⁺, Gd³⁺, Ce³⁺, La³⁺ and Cr⁴⁺, and mixtures thereof. In one embodiment the MOFs can be impregnated with metal salts based on any of Sc³⁺, Ti⁴⁺, V⁵⁺, V⁴⁺, V³⁺, Cr³⁺, Cr²⁺, Mn³⁺, Mg²⁺, Fe³⁺, Fe²⁺, Co³⁺, Co²⁺, Ni²⁺, Ni⁺, Cu²⁺, Cu⁺, Zn²⁺, and Ag⁺, and mixtures thereof.

The PSA separation method is a gas separation and purification method using a principle of selectively adsorbing specific gas in a gas mixture at a high pressure and then lowering the pressure to desorb the adsorbed gas. For this, a step of pressurization of the adsorption columns is performed. The dehumidified gas stream in line 136 is passed to the first adsorption column by opening an inlet valve. The first adsorption column is filled with the adsorbent in one or more beds for selectively adsorbing the fluorinated compounds including perfluorinated compounds. The second adsorption column remains on stand-by mode operation as its inlet valve remains closed. The first adsorption column is pressurized to atmospheric pressure or higher in order to adsorb large quantities of the fluorinated compounds to the adsorbents.

The adsorbent material may typically have a finite capacity to adsorb the target one or more fluorinated compounds. The adsorption capacity may desirably be cyclically restored by desorbing the one or more fluorinated compounds and any other components adsorbed on the adsorbent material. Typically, in such an embodiment, the desorbing of one or more fluorinated compounds adsorbed on the adsorbent material may desirably be carried out before the adsorbent capacity of the first adsorption column has been reached. For the desorption step, the flow of the dehumidified gas stream in line 136 to the first adsorption column is stopped by closing the inlet valve. A blowdown depressurizing of the first adsorption column is performed to desorb the adsorbed fluorinated compounds. The flow of the dehumidified gas stream in line 136 is diverted to the second adsorption column by opening its inlet valve. The step of blowdown depressurizing to desorb the adsorbed fluorinated compounds is continuously or repetitively carried out to separate and concentrate the selectively adsorbed fluorinated compounds. The desorbed fluorinated compounds may be discharged from the first adsorption column by opening its outlet valve. Similarly, the adsorption and desorption steps may be performed for the second adsorption column. The desorbed fluorinated compounds may be discharged from the second adsorption column by opening its outlet valve.

A concentrated fluorinated compound gas stream comprising the fluorinated compounds including perfluorinated compounds is discharged from the PSA unit 141 in line 156. The concentrated fluorinated compound gas stream in line 156 comprises a higher concentration of the fluorinated compounds than the gases discharged from the semiconductor etching tool or tools. In an exemplary embodiment, the concentrated fluorinated compound gas stream in line 156 may comprise greater than about 50 mol % fluorinated compounds or preferably from about 60 mol % to about 80 mol % one or more fluorinated compounds. In an embodiment, the concentrated fluorinated compound gas stream in line 156 may be compressed to a third pressure in a third compressor 160 to provide a compressed concentrated fluorinated compound gas stream in line 162. The third pressure may be about 5000 kPa (gauge) (725 psig) to about 15000 kPa (gauge) (2176 psig). The compressed concentrated fluorinated compound gas stream in line 162 may be stored and transported to off-site for further processing.

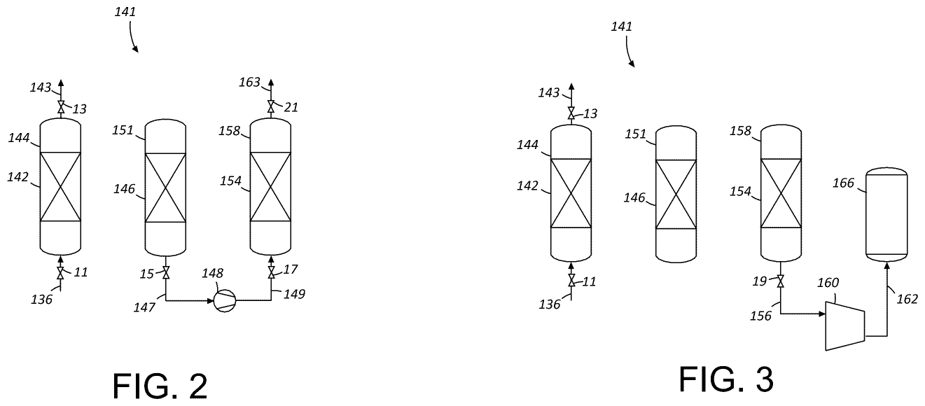

FIGS. 2 and 3 show two modes of operation of an embodiment of the PSA unit 141 in FIG. 1 that employs three adsorbent beds. In an exemplary embodiment, the PSA unit 141, as shown in FIGS. 2 and 3, may comprise three adsorbent beds, a first bed 142 in a first adsorbent vessel 144, a second bed 146 in a second adsorbent vessel 151, and a third bed 154 in a third adsorbent vessel 158.

In FIG. 2, the first bed 142 is in adsorption mode and the second bed 146 is in desorption mode. In FIG. 2, the dehumidified gas stream in line 136 may be passed to the first bed 142 through and open inlet valve 11 while the second bed 146 may be under desorption mode. In the first bed 142, the dehumidified gas stream in line 136 flows over the adsorbent and the fluorinated compounds are adsorbed during the adsorption step. The rest of the inert gas such as nitrogen gas passes through the adsorbent and exits as the fluorinated compound depleted gas stream in line 143 from the first bed 142 through the open outlet valve 13. The fluorinated compound depleted gas stream in line 143 may comprise about 10 to about 25 ppm fluorinated compounds.

In an aspect, the second bed 146 may be under desorption mode in FIG. 2. In desorption mode, the outlet valve 15 of the second bed 146 is open. A vacuum pump 148 may be used to pull the adsorbed fluorinated compounds from the second bed 146 along with inert gas in the second vessel 151 in an outflow stream in line 147. The pump 148 charges the outflow stream in line 147 comprising the fluorinated compounds to the third vessel 158 comprising the third bed 154 in an inflow line 149 through an open inlet valve 17. In an embodiment, the third bed 154 may be a fluorinated compounds concentrator bed. The third bed 154 may further concentrate the fluorinated compounds to provide a concentrated stream of fluorinated compounds. The inflow stream of fluorinated compounds in line 149 flows over the adsorbents and the fluorinated compounds are adsorbed during the adsorption step in the third bed 154. Inert gas exits the vessel in line 163 through an open valve 21 and may join the stream in line 143. In an aspect, the inert gas in line 163 and the fluorinated compound depleted gas stream in line 143 may be combined and a combined inert gas stream may be passed to the dehumidifier 135 in FIG. 1 for regenerating a desiccant bed.

Once the desorption step of the second bed 146 is completed, the valve 21 on line 163 is closed, the second bed 146 is ready for adsorption and the dehumidified gas stream in line 136 can be diverted to the second bed 146 while the first bed 142 can be subjected to desorption.

FIG. 3 illustrates the evacuation of the vessel 158 and desorption of the third bed 154 to concentrate the fluorinated compounds in line 162 perhaps to a vessel such as cylinder 166. At this stage, the regeneration step of the second bed 146 is completed and the second vessel 151 is moved to stand-by mode or it can be moved to active mode to receive the dehumidified gas stream in line 136 while the first bed 142 awaits desorption.

The concentrated fluorinated compounds which are adsorbed on the adsorbent in the third bed 154 of the third adsorption vessel 158 are discharged by opening the outlet valve 19 on line 156. For this, a third compressor 160 is used to evacuate the adsorbed fluorinated compounds from the third bed 154 in line 156. In an exemplary embodiment, the third compressor 160 may be a pump. The compressor 160 may evacuate the adsorbed fluorinated compounds from the third bed 154. A concentrated fluorinated stream comprising the fluorinated compounds is discharged in line 162 by the compressor 160. The concentrated stream in line 162 may be passed to a storage vessel 166 for storing the concentrated fluorinated compounds. The vessel 166 may comprise 30 to 50 mol % fluorinated compounds.

### Example (Prophetic)

Exhaust gas streams can be taken from the semiconductor etching tools at a volumetric flow rate of 22 m³/tool at atmospheric pressure. The total flow rate of the gas streams and the compositions can be as below in Table 1:

TABLE 1

| | Total flow rate of exhaust gases from | |
|---|---|---|
| | tools (m³/hr) | 2452.5 |
| Purge gas (N2) | Purge gas flow rate (m³/hr) | 2450 |
| Fluorinated compounds | NF3 and CF4 flow rate (m³/hr) | 2.5 |

The exhaust gases can contain moisture which can be about 28000 ppmv. The exhaust gases can be cooled to a temperature of about −75° C. at a pressure of about 5 bar to reduce the moisture level to about 5 ppmv. After cooling, the cooled gases can be contacted with a MOF adsorbent in the PSA unit. A concentrated gas stream could be desorbed from the PSA unit at a volumetric flow rate of about 4.5 m³/hr. The concentration of the fluorinated compounds in concentrated gas stream can be as below in Table 2.

TABLE 2

| | Concentration of | Concentration of |
|---|---|---|
| | Fluorinated | Fluorinated |
| | Compounds in the | Compounds in the |
| | Exhaust Gas | Concentrated Gas |
| By volume | 0.15% | 45% |
| By weight | 0.3% | 75% |

Although the process for treating gases discharged from a semiconductor etching tool has been described in detail in connection with the above description and example, it is to be understood that such detail is solely for that purpose and that variations can be made by those skilled in the art without departing from the spirit of the disclosure except as it may be limited by the following claims.

What is claimed is:

1. A process for treating a gas stream, comprising:
passing a dilute fluorinated gas stream comprising a fluorinated compound to a scrubber to remove reactive gases and provide a scrubbed gas stream;
adsorbing the fluorinated compound in said scrubbed gas stream onto an adsorbent in an adsorption unit;
desorbing the fluorinated compound from said adsorbent to discharge a concentrated fluorinated compound gas stream from the adsorption unit.

2. The process of claim 1, wherein said dilute fluorinated gas stream is discharged from a semiconductor etching tool.

3. The process of claim 1, wherein said at least one adsorbent is selected from a group comprising metal organic frameworks, activated carbon, zeolites, silica, alumina and porous polymers.

4. The process of claim 1 further comprising:
cooling said scrubbed gas stream in a cooler to separate a liquid stream from said scrubbed gas stream comprising said fluorinated compound; and
charging said scrubbed gas stream comprising said fluorinated compound to the adsorption unit.

5. The process of claim 4 further comprising passing said liquid stream to the scrubber at a location below an inlet of said dilute fluorinated gas stream.

6. The process of claim 4 further comprising:
dehydrating said scrubbed gas stream to produce a dehydrated gas stream comprising less than 3 ppm by volume of water; and
charging said dehydrated gas stream to the adsorption unit.

7. The process of claim 1, wherein dilute fluorinated gas stream comprises about 0.1 mole % to about 10 mole % fluorinated compound.

8. The process of claim 1 further comprising:
compressing said dilute fluorinated gas stream to provide a compressed dilute fluorinated gas stream having a pressure of about 100 kPa (gauge) to about 600 kPa (gauge); and
passing said compressed dilute fluorinated gas stream to the scrubber.

9. The process of claim 1, wherein the adsorption unit comprises one or more of a pressure swing adsorption column, a thermal swing adsorption column, or a vacuum swing adsorption column.

10. The process of claim 4 further comprising:
compressing said scrubbed gas stream to provide a compressed gas stream at a pressure of about 200 kPa (gauge) to about 600 kPa (gauge); and
passing said compressed gas stream to the cooler.

11. A process for treating gases, comprising:
scrubbing a dilute fluorinated gas stream comprising a fluorinated compound selected from hexafluoroethane, trifluoromethane, octafluoropropane, tetrafluoromethane, sulphur hexafluoride, and nitrogen trifluoride in a scrubber to provide a scrubbed gas stream;
separating water from said scrubbed gas stream to provide a dehydrated gas stream;
adsorbing said fluorinated compound in said dehydrated gas stream onto an adsorbent in an adsorption unit;
desorbing said fluorinated compound from said adsorbent; and
discharging a concentrated fluorinated compound gas stream from said adsorption unit.

12. The process of claim 11, wherein said adsorbent is selected from a group comprising metal organic frameworks, activated carbon, zeolites, silica, alumina and porous polymers.

13. The process of claim 11, wherein said dilute fluorinated gas stream to be treated is discharged from a semiconductor etching tool.

14. The process of claim 11 further comprising:
cooling said scrubbed gas stream in a cooler to separate a liquid stream from said scrubbed gas stream comprising said fluorinated compound.

15. A process for treating gases, comprising:
scrubbing a first compressed gas stream at a first pressure, the first compressed gas stream comprising a fluorinated compound to provide a scrubbed gas stream;
compressing said scrubbed gas stream to a second pressure to provide a second compressed gas stream, wherein the second pressure is higher than the first pressure;
adsorbing one or more of hexafluoroethane, trifluoromethane, octafluoropropane, tetrafluoromethane, sulphur hexafluoride, and nitrogen trifluoride in said second compressed gas stream on an adsorbent;
desorbing a concentrated fluorinated gas stream from said adsorbent; and
compressing said concentrated fluorinated gas stream to a third pressure, wherein the third pressure is higher than the second pressure.

16. The process of claim 15 further comprising:
passing a dilute fluorinated gas stream to a first compressor operating at an outlet pressure of about 100 kPa (gauge) to about 600 kPa (gauge) to provide said first compressed gas stream.

17. The process of claim 15, wherein the second pressure is about 200 kPa (gauge) to about 600 kPa (gauge).

18. The process of claim 15, wherein the third pressure is about 5000 kPa (gauge) to about 15000 kPa (gauge).

19. The process of claim 16, wherein said dilute fluorinated gas stream is discharged from a semiconductor etching tool.

20. The process of claim 15, wherein said adsorbent is selected from a group comprising metal organic frameworks, activated carbon, zeolites, silica, alumina and porous polymers.
